(19) United States
(12) Patent Application Publication
(10) Pub. No.: US 2002/0137553 A1
(43) Pub. Date: Sep. 26, 2002

(54) Distinctive ringing for mobile devices using digitized user recorded audio message

(76) Inventor: Tim D. Kraemer, The Woodlands, TX (US)

Correspondence Address: CONLEY ROSE & TAYON, P.C., P. O. BOX 3267, HOUSTON, TX, 77253-3267, US

(21) Appl. No.: 09/814,917

(22) Filed: Mar. 22, 2001

(51) Int. Cl. H04M 1/00

(52) U.S. Cl. 455/567; 455/566; 455/412

(57) ABSTRACT

A mobile communication device that produces a distinctive ring message to inform users of an incoming call or page and includes a transmit/receive module, display and keypad all coupled to a system bus. A central processing unit (CPU) also couples to the system bus. Connected to the CPU through a CPU bus is a Random Access Memory (RAM) and programmable Read Only Memory (ROM). The programmable ROM stores the user generated distinctive ring message that informs the user of an incoming call or page. The transmit/receive module is connected to a speaker and a microphone. The transmit/receive module contains a analog to digital converter that digitizes incoming speech for storage into the programmable ROM. The user records a unique audio message into the mobile communication device that plays to inform the user of an incoming call or page.

### BACKGROUND OF THE INVENTION

1. Field of the Invention

The present invention generally relates to a mobile communication device that includes a digitizing circuit and memory storage device to generate a distinctive ring message. More particularly, the invention relates to a mobile communication device with a programmable Read Only Memory that stores a user generated distinctive ring message that alerts the user of an incoming phone call or page.

### BACKGROUND OF THE INVENTION

A mobile communication device operates in a wireless communication system to provide a user with portable communications. Mobile communication devices communicate with other mobile communication devices via electromagnetic signals, such as, for example, those in the radio frequency (RF) range. The mobile communication device may communicate voice only, data only or both voice and data. The format of the electromagnetic signal communicated between the mobile communication devices may be either analog or digital. Examples of mobile communication devices include cellular telephones, pagers, personal data assistants, and notebook computers. The personal data assistants and notebook computers may include built-in cellular telephone or pager hardware and software features.

Mobile communication devices use various alert techniques to indicate to a user that an incoming signal has been received. For example, a cellular telephone alerts the user when an incoming call signal is received, and a pager alerts the user when an incoming page signal is received. Generally, these alert techniques include audible, visual and tactile alert generators. The audible alert generator is typically implemented with an acoustic transducer, i.e., a speaker, sometimes known as a ringer.

Audible alert generators are generally known to be implemented in virtually all mobile communication devices. When a desired signal has been received, the mobile communication device activates the audible alert generator to produce a sound, such as a ring or beep, thereby alerting the user. A problem with audible alert generators is that the tones or rings produced for most mobile communication devices are the same, thus producing confusion amongst mobile communication device users who may overhear another user's mobile communication device and think that their mobile device is ringing.

In telephone systems that are connected by physical telephone lines (i.e., landline telephone systems), landline telephones (also known as landline telephone subscriber units) have audible alert generators and can generate distinctive audible alert patterns, such as distinctive ringing, responsive to signals generated by the landline telephone system. Generally, distinctive ringing consists of sequenced, variable-length bursts of power ringing interspersed with variable length silent intervals. Distinctive ringing for landline telephone subscriber units is described in Bellcore's LATA Switching Systems Generic Requirements, Class^{SM} Feature: Distinctive Ringing/Call Waiting, FSD 01-01-1110, TR-TSY-000219, Issue 2, November 1988, Revision 1, May 1992.

In a cellular telephone system or pager system, cellular telephone or pager subscriber units have audible alert generators and can generate distinctive audible alert patterns, such as distinctive ringing, responsive to alert codes. Generally, distinctive ringing in the cellular telephone system or pager system is implemented by varying the pitch and cadence or duty cycle, of the audible alert signal. Pitch represents a distinction between tones, usually based on frequency. Cadence or duty cycle is the on/off pattern of the tones. Distinctive ringing for subscriber units is described in EIA/TIA INTERIM STANDARD, Cellular System Dual-Mode Mobile Station-Base Station Compatibility Standard, IS-54-B, Section 2.7.3.1.3.3.1, Telecommunications Industry Association, April 92.

To date, cellular telephone or pager systems that can generate distinctive audible alert ring patterns responsive to alert codes are limited by the small number of audible alert ringing patterns available. Thus, users of cellular telephones or pagers still may be confused by hearing another user's device that uses the same audible alert ring pattern that the user has selected.

It would be advantageous if a simple method and apparatus could be implemented that generates distinctive ringing in a mobile communication device to eliminate confusion regarding the source of the ringing. It would also be advantageous if the user of the mobile communication device is able to specify the unique audio message used as the distinctive ring alert. Despite the apparent advantages of such a system, to date no such system has been implemented.

### SUMMARY OF THE INVENTION

The problems noted above are solved in large part by a mobile communication device that produces a distinctive ring message to inform users of an incoming call or page. The mobile communication device preferably includes a transmit/receive module, display and keypad all coupled to a system bus. A central processing unit (CPU) also couples to the system bus. Connected to the CPU through a CPU bus is a Random Access Memory (RAM) and programmable Read Only Memory (ROM). The programmable ROM stores the user generated distinctive ring message that is used by the mobile communication device to inform the user of an incoming call or page.

The transmit/receive module connects to a speaker and a microphone. The transmit/receive module contains a digital to analog converter coupled to the system bus, with the converter decoding a digital encoded signal into a corresponding analog signal. The converter transmits the analog signal to an amplifier that then outputs an amplified audio signal corresponding to the distinctive ring message to the audio speaker. The transmit/receive module also contains an analog to digital converter connected to the system bus. The converter receives as input an analog electrical signal corresponding to a distinctive ring message sound wave, sampling the signal, encoding the sampled signal into digital values, and outputting the digital values to the system bus.

Generating distinctive ringing using the mobile communication device requires the user to record a unique audio message into the device. Recording a unique audio message into the device involves the steps of (a) initiating a recording function, (b) generating a distinctive ring message into a microphone coupled to the mobile communication device, (c) halting the recording function, (d) replaying the distinctive ring message and if the message is not satisfactory performing steps (a)-(d) and (e) placing the mobile communication device into a ring-to-alert-user state that informs the user when an incoming call or page is detected by playing the distinctive ring message.

### BRIEF DESCRIPTION OF THE DRAWINGS

For a detailed description of the preferred embodiments of the invention, reference will now be made to the accompanying drawings in which:

FIG. 1 shows exemplary hardware for implementing a mobile communication device in accordance with the preferred embodiment of the present invention;

FIG. 2 shows the transmit/receive module of FIG. 1 that performs analog-to-digital conversion of an input signal and digital-to-analog conversion of an output signal; and

FIG. 3 shows a flowchart depicting a preferred method for a user to specify a distinctive ring message for a mobile communication device.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . .”. Also, the term “couple” or “couples” is intended to mean either an indirect or direct electrical connection. Thus, if a first device couples to a second device, that connection may be through a direct electrical connection, or through an indirect electrical connection via other devices and connections.

### DESCRIPTION OF THE PREFERRED EMBODIMENTS

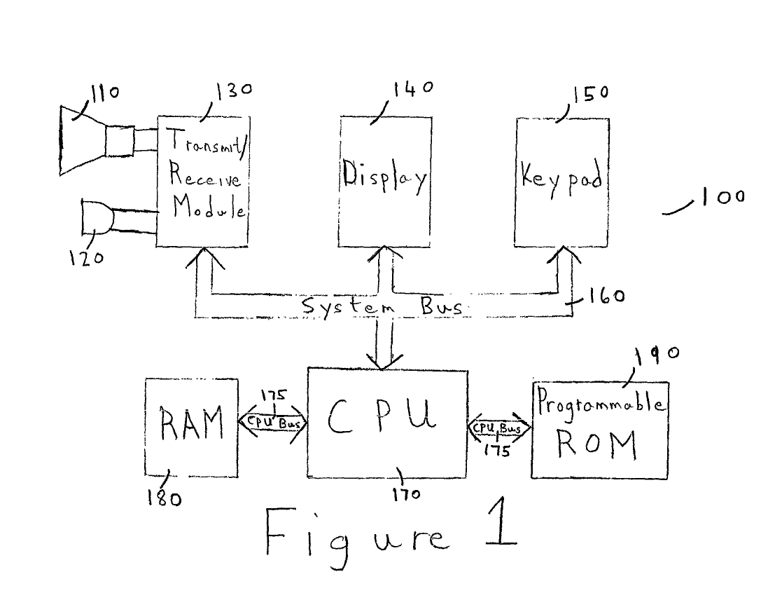

Referring now to FIG. 1, mobile communication device 100 constructed in accordance with the preferred embodiment of the present invention comprises a speaker 110 and microphone 120 coupled to a transmit/receive module 130. The transmit/receive module 130 preferably couples to a display 140 through a system bus 160. A keypad 150 and Central Processing Unit (CPU) 170 also couple through the system bus 160 to the display 140 and transmit/receive module 130. The CPU couples to Random-Access-Memory (RAM) and Programmable Read-Only-Memory (ROM) storage devices. The following discussion describes each of these blocks in more detail. The speaker 110 may be any audio speaker capable of reproducing sound across the range of frequencies audible to humans. Speaker 110 receives amplified signals from the transmit/receive module 130 and converts those signals to sound energy audible to humans. Sound generated by speaker 110 should be of such magnitude that it can be heard in an environment with high ambient noise or in the event the speaker is muffled by clothing or other object (i.e., the mobile communication device is in the user's pocket or purse).

Microphone 120 may be any electroacoustic transducer that responds to sound waves and outputs corresponding electric waves. The electric waves typically are in analog form. These electric signals are received by the receive module 130, which then digitizes the analog signals into a digital signal using an analog-to-digital converter. Microphone 120 should be designed to distinguish human speech directed towards the microphone from ambient noise from the surrounding environment.

Transmit/receive module 130 receives analog carrier wave forms from microphone 120. The carrier waveform may encode analog or digital information depending on the object (i.e., human voice, modem etc.) generating the sound waves into the microphone 120. Decoding is the process of extracting information content from the carrier waveform. A waveform containing digital information is decoded and then information relating to the waveform is placed on the system bus 160. A waveform containing analog information is decoded and digitized into a digital signal and output to system bus 160. The transmit/receive module 130 also receives through the system bus digital signals from the display, keypad or CPU and converts these digital signals to analog waveforms for sound generation by speaker 110. Transmit/receive module 130 may also receive analog signals from mobile communication device transceiver hardware (not shown in FIG. 1) that allows wireless communication. The analog signals are transmitted to speaker 110 to generate sound.

The display 140 in the preferred embodiment is a multiline (for example, 4 to 5 text lines) alphanumeric display that may be implemented as a dot matrix addressable display or a combination of a dot matrix addressable display and dedicated icons or symbols. Alternatively, in another preferred embodiment, the display may comprise a conventional PDA or notebook display monitor capable of generating VGA quality graphics. In the preferred embodiment, the display 11 is implemented using a liquid crystal display, but other display technologies, such as light emitting diode (LED), thin film transistor (TFT) etc., may be used.

In one preferred embodiment, keypad 150 of the mobile communication device may comprise a conventional telephone keypad with dedicated keys for the functions “SEND”, “END”, and “POWER”. In the preferred embodiment, the keypad also includes a set of programmable keys that have an initial dedicated function, but are also programmable in the sense that additional functions can be assigned to any of the keys. In addition, a number of “soft” keys may be present. Text messages, icons, or the like may be associated with any one of the soft keys by displaying the associated symbol or text directly above a soft key on a display. The keys of mobile communication device keypad 150 may be implemented using any convenient keyboard technology, such as touch panel, membrane, mechanical, or optical switches.

Referring still to FIG. 1, Central Processing Unit (CPU) 170 can be any standard microcontroller, digital signal processor, or microprocessor that is capable of real time processing of the data carried by system bus 160 enabling the mobile communication device to receive and transmit incoming telephone calls and pages. The CPU may be a Motorola MC68HC05 or MC68HC11 microcontroller or a Texas Instruments TMS 320 digital signal processor. In another preferred embodiment, if the mobile communication device is a PDA or notebook computer the CPU may be a Pentium™ or AMD Atholon™ series microprocessor. The CPU is not limited to the particular microcontrollers, digital signal processors, or microprocessors named above but can be any equivalent hardware that is capable of real time processing of the data carried by system bus 160.

The CPU 170 receives data from the transmit/receive module 130, including digitized voice streams from the transmit/receive module 130 and key press signals from keypad 150 and processes these signals to generate video output for display 140 and audio output for speaker 110. CPU bus 175 couples the CPU 170 to RAM 180 and Programmable ROM 190, which store data used by the CPU 170 to generate distinctive ringing for mobile communication devices using digitized audio messages as in the preferred embodiment of the invention. The CPU 170 preferably can access RAM 180 and Programmable ROM 190 concurrently because of the high bandwidth design of the CPU bus 175 to permit processing of signals in real time.

Referring still to FIG. 1, in accordance with the preferred embodiment, RAM memory 180 preferably comprises a conventional memory device or an array of memory devices in which application programs or data are stored during system operation. The capacity of RAM memory 180 can be any suitable size. Further, RAM memory 180 preferably is any suitable type of memory such as Dynamic Random Access Memory (DRAM) or any of the various types of DRAM circuits such as synchronous dynamic random access memory (SDRAM).

In accordance with the preferred embodiment, programmable ROM 190 comprises a memory device capable of storing data, even with power removed. The programmable ROM 190 may be an Electronically Programmable Logic Device (EPLD), Programmable Logic Array (PLA), or any other type of memory storage device that has the capability to store data that can be altered using conventional write operations.

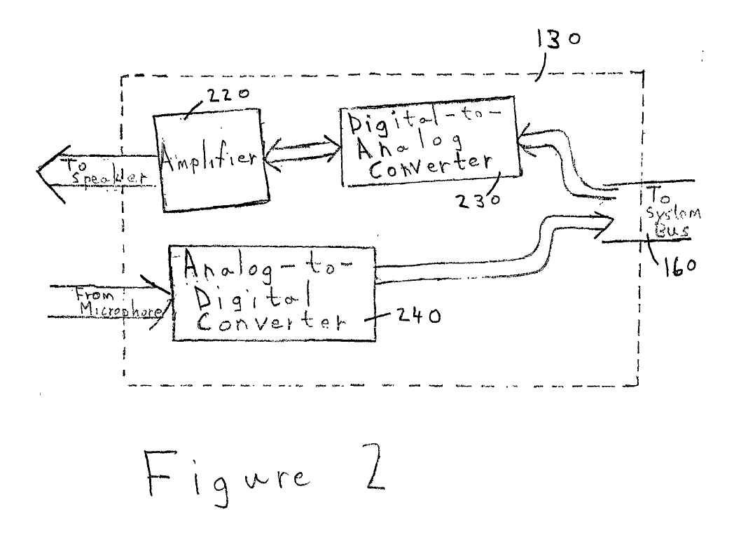

Turning now to FIG. 2, the transmit/receive module 130 is shown in more detail. The transmit/receive module 130 preferably includes an amplifier 220 coupled to a digital-to-analog converter (DAC) 230, and an analog-to-digital converter (ADC) 240. The amplifier 220 and DAC 230 form part of an audio output path, while analog-to-digital converter 240 forms part of an audio input path. In addition, transmit/receive module 130 preferably includes hardware (not shown in FIG. 2) for carrying on a telephone call or for receiving a page.

The audio input path receives sound waves and converts these sound waves to digital form for further processing by the system. Analog-to-digital converter 240 receives analog sound waves from microphone 120 and digitizes the waves into discrete units. The analog-to-digital converter 240 may be any conventional converter that has a high enough sampling rate to allow digitization of real time human speech signals. The digitized speech signal is then transmitted to system bus 160, for processing by CPU 170.

The audio output path operates in reverse, and converts digital data to sound waves. CPU 170 or keypad 150 generate data that may have to be output to speaker 110. The data is sent from keypad 150 or CPU 170 via the system bus 160 to digital-to-analog converter 230 that converts the digital data into an analog sound signal. Amplifier 220 then receives the analog sound signal from digital-to-analog converter 230 and amplifies the signal to an appropriate level for output to speaker 110 as sound waves.

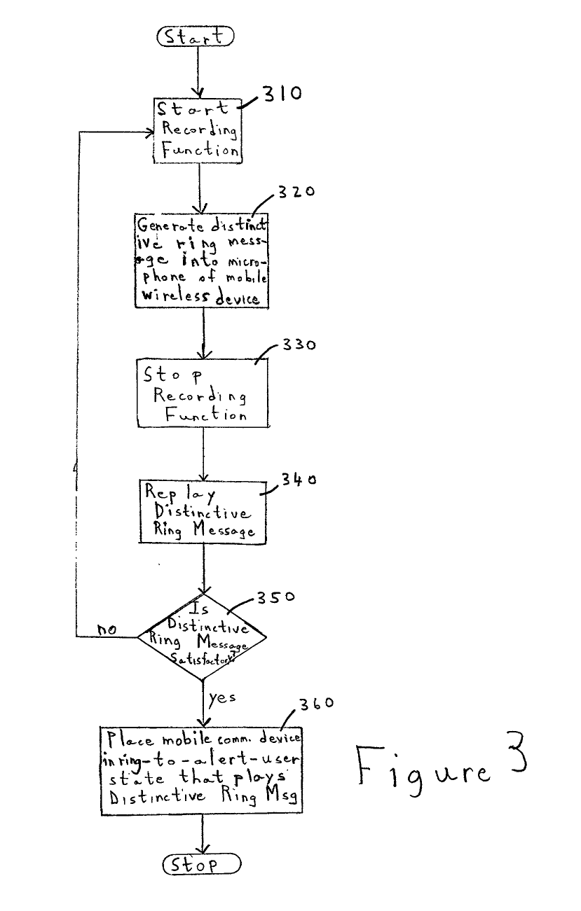

Turning now to FIG. 3, one method of generating distinctive ringing for a mobile communication device in accordance with the preferred embodiment of the invention is shown. In step 310 of FIG. 3, the mobile communication device user begins recording the distinctive ring message by activating a record function on the device. In the preferred embodiment, activating the record function comprises pressing a “record” key located on the mobile communication device keypad 150. Alternatively, activating the record function may be a speech act such as speaking “begin recording” into microphone 120 for a mobile communication device that has the capability to recognize speech commands. Many other ways of activating the “record” function exist and can be implemented. After the user starts the record function, in step 320 the user generates a distinctive ring message using microphone 120. Generation of the distinctive ring message may comprise the user speaking into microphone 120 or using a musical instrument or music synthesizer device to create a message. Other equivalent and alternative ways of creating a distinctive ring message exist and may be used as is well known to individuals in the art. The distinctive ring message is converted into digital format by the transmit/receive module 130 and processed by the CPU 170 before being stored into programmable ROM 190.

After generation of the distinctive ring message, in step 330 the user stops the record function which in the preferred embodiment comprises pressing a “stop recording” key located on the mobile communication device. Many other ways of activating the “stop recording” function exist and can be implemented. After recording of the distinctive ring message is complete, the distinctive ring message is played in step 340 to permit the user to review the message. If the distinctive ring message is not satisfactory to the user in step 350, the user may again activate the recording function in step 310 and generate another distinctive ring message. Once the user is satisfied with the distinctive ring message, the user then places the mobile communication device into a ring-to-alert-user state that informs the user when an incoming call or page is detected by using the distinctive ring message.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A mobile communication device that produce a distinctive ring message to inform users of an incoming call or page, comprising:
a transmit/receive module coupled to a system bus;
a display coupled to said system bus;
a keypad coupled to said system bus;
a central processing unit (CPU) coupled to said bus, said CPU coupling to a Random Access Memory (RAM) and programmable Read Only Memory (ROM); and
wherein said programmable ROM stores the user generated distinctive ring message that is used by the mobile communication device to inform the user of an incoming call or page.

2. The mobile communication device of claim 1 wherein the transmit/receive module is coupled to a speaker.

3. The mobile communication device of claim 2 wherein the transmit/receive module further comprises a digital-to-analog converter coupled to the system bus, said converter decoding a digital encoded signal into a corresponding analog signal, outputting said analog signal to an amplifier that then outputs an amplified audio signal corresponding to the distinctive ring message to the speaker.

4. The mobile communication device of claim 1 wherein the transmit/receive module is coupled to a microphone.

5. The mobile communication device of claim 4 wherein the transmit/receive module further comprises an analog-to-digital converter coupled to the system bus, said converter receiving as input an analog electrical signal corresponding to a sound wave, sampling the signal, encoding the sampled signal into digital values, and outputting the digital values to the system bus.

6. The mobile communication device of claim 5 wherein the sound wave corresponds to the distinctive ring message that is generated by the user into the microphone.

7. The mobile communication device of claim 1 wherein the CPU includes a mode for recording the distinctive ring message.

8. The mobile communication device of claim 1 wherein the CPU plays back the distinctive ring message in response to an incoming call or page.

9. A method of generating distinctive ringing for mobile communication devices using a digitized user recorded audio message, comprising:
(a) initiating a recording function;
(b) generating a distinctive ring message into a microphone coupled to the mobile communication device;
(c) halting the record function;
(d) replaying the distinctive ring message and if the message is not satisfactory performing steps (a)-(d); and
(e) placing the mobile communication device into a ring-to-alert-user state that informs the user when an incoming call or page is detected by playing the distinctive ring message.

10. A method as in claim 9, wherein initiating the recording function comprises pressing a “record” key.

11. A method as in claim 9, wherein initiating the recording function comprises a “start recording” voice command recognized by the mobile communication device.

12. A method as in claim 9, wherein generating the distinctive ring message further comprises the user speaking into the microphone.

13. A method as in claim 9, wherein generating the distinctive ring message further comprises the user using a musical instrument or music synthesizer device to create a distinctive ring message.

14. A method as in claim 9, wherein halting the recording function comprises pressing a “stop recording” key.

15. A method as in claim 9, wherein halting the recording function comprises a “stop recording” voice command recognized by the mobile communication device.

16. A mobile communication device that produce a distinctive ring message to inform users of an incoming call or page, comprising:
a transmit/receive module coupled to a system bus;
a display coupled to said system bus;
a keypad coupled to said system bus;
a central processing unit (CPU) coupled to said bus, said CPU coupling to a Random Access Memory (RAM) and programmable Read Only Memory (ROM) through a CPU bus; and
wherein said programmable ROM stores the user generated distinctive ring message that is used by the mobile communication device to inform the user of an incoming call or page.
